(19) United States
(12) Patent Application Publication
(10) Pub. No.: US 2014/0123654 A1
(43) Pub. Date: May 8, 2014

(54) FUEL METERING VALVE SYSTEM

(71) Applicant: GENERAL ELECTRIC COMPANPY, Schenectady, NY (US)

(72) Inventors: Alan James Kemmerer, Spring, TX (US); Michael Feinstein, Houston, TX (US)

(73) Assignee: GENERAL ELECTRIC COMPANPY, Schenectady, NY (US)

(21) Appl. No.: 13/670,498

(22) Filed: Nov. 7, 2012

(51) Int. Cl. F02C 9/26; F02C 7/232

(52) U.S. Cl. CPC F02C 9/263; F02C 7/232
USPC 60/741; 60/742; 60/776

(57) ABSTRACT

A fuel metering valve system for use with a flow of fuel in a gas turbine engine may include a number of orifice plate lines, a number of differently sized orifice plates, and a number of orifice plate line valves. One of the orifice plate line valves opens and closes one of the orifice plates on the orifice plate lines.

### TECHNICAL FIELD

The present application and the resultant patent relate generally to gas turbine engines and more particularly relate to a fuel metering valve system with a number of differently sized orifice plates operating in an on and off fashion depending upon demand.

### BACKGROUND OF THE INVENTION

Generally described, the flow of fuel to a combustor of a gas turbine engine may be carefully monitored and controlled such that the gas turbine engine produces the required output while remaining compliant with emissions regulations. Changes in output demands as well as changes in various other types of operational parameters may result in changes in fuel demand. Fuel flow controllers thus need the capability to provide very precise adjustments in the flow of fuel to meet such demands. Specifically, fuel flow controllers must provide reliable operational and emissions control over a wide range of loads, ambient conditions, fuel compositions, and other types of operational parameters.

Gas turbine engines generally use a fuel metering valve on each incoming fuel line. By way of example, these known fuel metering valves may include an electronically actuated ball valve positioned within the fuel line with an onboard, electronic position controller. The fuel flow controller thus actuates the ball valve based upon the position controller so as to control the volume of the flow of fuel through the fuel line. Such known fuel metering valves, however, may be somewhat complex, may be somewhat expensive, may require periodic calibration, and may not be easily repairable in the field.

There is thus a desire for an improved fuel metering valve system for use in gas turbine engines. Such an improved fuel metering valve system may provide precise adjustments to the flow of fuel in a fast and efficient manner with improved overall reliability and lower costs.

### SUMMARY OF THE INVENTION

The present application and the resultant patent thus provide a fuel metering valve system for use with a flow of fuel to a combustor in a gas turbine engine. The fuel metering system may include a number of orifice plate lines, a number of differently sized orifice plates, and a number of orifice plate line valves. One of the orifice plate line valves opens and closes one of the orifice plates on the orifice plate lines.

The present application and the resultant patent further describe a method of providing a flow of fuel to a combustor of a gas turbine engine. The method may include the steps of providing a number of differently sized orifice plates in a parallel arrangement in communication with the flow of fuel, opening a first one of the differently sized orifice plates to meet a first fuel demand, opening a second one of the differently sized orifice plates to meet a second fuel demand, and opening all of the differently sized orifice plates to meet a full load fuel demand.

The present application and the resultant patent further provide a fuel metering valve system for use with a flow of fuel in a gas turbine engine. The fuel metering valve system may include a number of orifice plate lines positioned in a parallel arrangement, a number of differently sized orifice plates, a number of orifice plate line valves, and a flow controller in communication with the orifice plate line valves so as to open and close the orifice plates.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine showing a compressor, combustor, a turbine, and a load.

FIG. 2 is a schematic diagram of a known fuel metering valve with an electrically actuated ball valve.

FIG. 3 is a schematic diagram of a fuel metering valve system as may be described herein.

### DETAILED DESCRIPTION

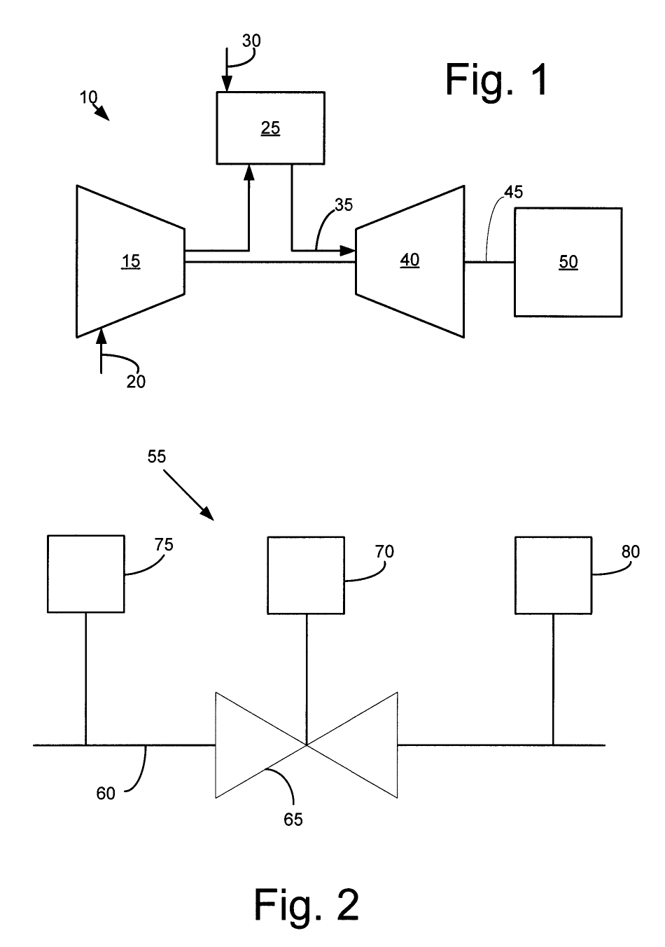

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels and combinations thereof. The gas turbine engine 10 may be any one of a number of different gas turbine engines offered by General Electric Company of Schenectady, New York, including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

FIG. 2 shows an example of a known fuel metering valve 55. The fuel metering valve 55 may be positioned on a fuel line 60 in communication with the combustor 25 for the flow of fuel 30 therethrough. As described above, the fuel metering valve 55 may include a ball valve 65 positioned within the fuel line 60. The ball valve 65 may be actuated by an electronic position controller 70. The electronic position controller 70 may be in communication with the overall gas turbine controller or other type of device. The electronic position controller 70 also may be in communication with an upstream pressure/temperature sensor 75 and a downstream pressure/temperature sensor 80 as well as other types of sensors so as to provide feedback and/or information on any type of operational parameter. The fuel metering valve 55 described herein is for the purpose of example only. Many other types of fuel metering valves and components may be known.

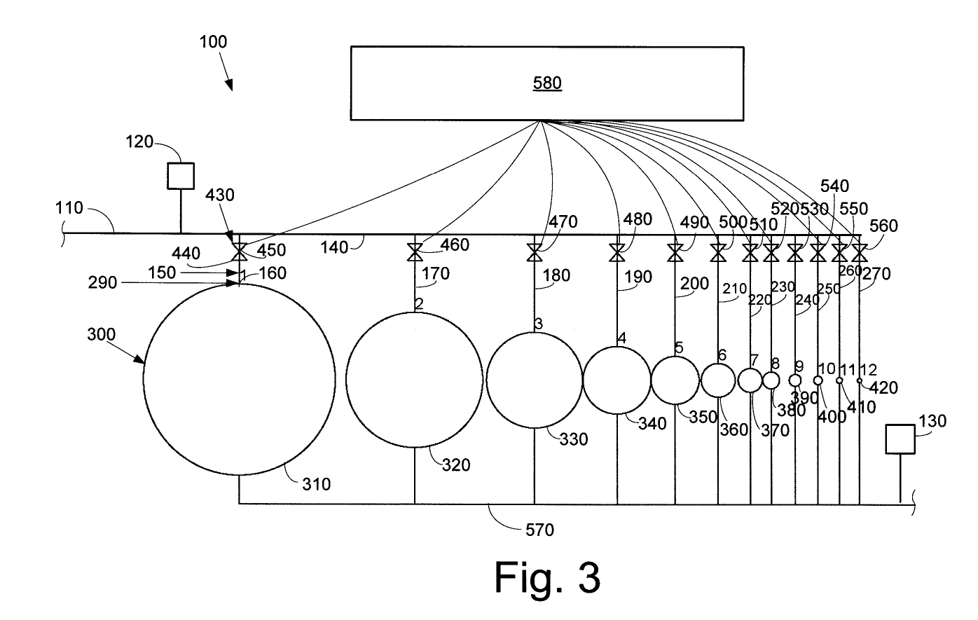

FIG. 3 shows a fuel metering valve system 100 as may be described herein. The fuel metering valve 100 may be positioned about an incoming fuel line 110. The incoming fuel line 110 may be in communication with the combustor 25 for the flow of fuel 30 therethrough. An upstream pressure/temperature sensor 120 may be positioned upstream of the fuel metering valve system 100. A downstream pressure/temperature sensor 130 may be positioned downstream of the fuel metering valve system 100. The pressure/temperature sensors 120, 130 may be of conventional design and may be communication with the overall gas turbine controller or other type of device. Other types of sensors may be used herein so as to monitor different type of operational parameters and the like.

The fuel metering valve system 100 may include an inlet manifold 140. The inlet manifold 140 may be in communication with the fuel line 110. The inlet manifold 1240 may be in communication with a number of orifice plate lines 150. Although twelve (12) orifice plate lines 150 are shown, any number may be used herein. Specifically, a first orifice plate line 160, a second orifice plate line 170, a third orifice plate line 180, a fourth orifice plate line 190, a fifth orifice plate line 200, a sixth orifice plate line 210, a seventh orifice plate line 220, an eighth orifice plate line 230, a ninth orifice plate line 240, a tenth orifice plate line 250, an eleventh orifice plate line 260, a twelfth orifice plate line 270 are shown. The orifice plate lines 150 thus have a parallel arrangement 290 as may be shown. The orifice plate lines 150 may have any size, shape, or configuration.

Each of the orifice plate lines 150 may include an orifice plate 300 thereon. Although twelve (12) orifice plates 300 are shown, any number may be used herein. Specifically, a first orifice plate 310, a second orifice plate 320, a third orifice plate 330, a fourth orifice plate 340, a fifth orifice plate 360, a sixth orifice plate 370, a seventh orifice plate 380, an eighth orifice plate 390, a ninth orifice plate 400, a tenth orifice plate 410, an eleventh orifice plate 420, and a twelfth orifice plate 430 are shown. Each orifice plate 300 may have a differently sized orifice as will be described in more detail below so as to allow a predetermined volume of the flow of fuel 30 to pass therethrough at a given flow rate. The orifice plates 300, however, may have any size, shape, or configuration.

Each orifice plate line 150 also may include an orifice plate line valve 440 thereon. The orifice plate line valve 440 may be a solenoid valve 450. Any type of on/off valve, however, may be used herein. Other types of flow control devices also may be used herein. Although twelve (12) orifice plate line valves 440 are shown, any number may be used herein. Specifically, a first orifice plate line valve 460, a second orifice plate line valve 470, a third orifice plate line valve 480, a fourth orifice plate line valve 490, a fifth orifice plate line valve 500, a sixth orifice plate line valve 510, a seventh orifice plate line valve 520, an eighth orifice plate line valve 530, a ninth orifice plate line valve 540, a tenth orifice plate line valve 550, an eleventh orifice plate line valve 560, and a twelfth orifice plate line valve 570 are shown. The orifice plate line valves 440 may have any size, shape, or configuration.

Each orifice plate line 150 also may be in communication with an outlet manifold 580. The outlet manifold 580 may be in communication with the fuel line 110 for the flow of fuel 30 to the combustor 25. Other components and other configurations may be used herein.

The fuel metering valve system 100 also may include a fuel flow controller 590. The fuel flow controller 590 may be in communication with each of the orifice plate line valves 440. The fuel flow controller 590 may operate the orifice plate valves 440 in a binary fashion, i.e., an on or off control. The fuel flow controller 590 may be any type of programmable logic device. The fuel flow controller 590 may be in communication with the overall gas turbine engine controls and the like. The fuel flow controller 590 also may be in communication with the pressure/temperature sensors 120/130 and/or other types of sensors and operational parameters.

The orifice plates 300 may be sized according to a percentage of the maximum flow of fuel 30 expected herein. For example, the smallest orifice plate, the twelfth orifice plate 430, may be sized for the smallest anticipated flow of fuel 30 while the next orifice plate, the eleventh orifice plate 420, may be sized to double that flow or to increase the flow by any predetermined percentage. For example, the orifice plates 300 may be sized according to the percentage of the flow as follows:

| Valve | 1 | 2 | 3 | 4 | 5 | 6 | 7 | 8 | 9 | 10 | 11 | 12 |
|---|---|---|---|---|---|---|---|---|---|---|---|---|
| Flow % | 50 | 25 | 12.5 | 6.25 | 3.10 | 1.60 | 0.80 | 0.40 | 0.20 | 0.10 | 0.05 | 0.03 |

These flow percentages are given by way of example only. Many other percentages of the flow of fuel 30 as well as other orientations of the orifice plates 300 may be used herein. By way of example only, the effective area of the respective orifice plates 300 may be based in part on the critical pressure ratio therethrough and whether the ratio of the valve discharge pressure over the valve inlet pressure is greater than or less than the critical pressure ratio. Other parameters may be considered herein.

The fuel metering valve system 100 described herein thus provides the orifice plates 300 in the parallel arrangement 290 with a common inlet manifold 140 and a common outlet manifold 580. Although twelve (12) orifice plates 300 are shown, any number may be used herein in any size, shape, or configuration. The fuel flow controller 590 thus operates the orifice plate line valves 430 in a binary fashion so as to produce a predetermine flow in proportion to the size of the open orifice plates 300. The fuel metering valve system 100 thus precisely and quickly satisfies changing fuel flow demands. The change in the flow of fuel 30 also may be predictable and accurate. Moreover, the fuel metering valve system 100 described herein may be significantly less complex than known systems so as to provide improved reliability, improved availability, as well as lower costs. The fuel metering valve system 100 may be field repairable, may provide redundancy, and may not require calibration.

The fuel metering valve system 100 described herein also may be used with the known fuel metering valve 55 described above or any type of conventional fuel metering valve. The fuel metering valve system 100 may be positioned in parallel or in series with any such conventional fuel metering valve and the like.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A fuel metering valve system for use with a flow of fuel in a gas turbine engine, comprising:
a plurality of orifice plate lines;
a plurality of differently sized orifice plates; and
a plurality of orifice plate line valves;
wherein one of the plurality of orifice plate line valves opens and closes one of the plurality of orifice plates on the plurality of orifice plate lines.

2. The fuel metering valve system of claim 1, further comprising an inlet manifold in communication with the plurality of orifice plate lines.

3. The fuel metering valve system of claim 1, further comprising an upstream pressure-temperature sensor upstream of the plurality of orifice plate lines.

4. The fuel metering valve system of claim 1, further comprising an outlet manifold in communication with the plurality of orifice plate lines.

5. The fuel metering valve system of claim 1, further comprising a downstream pressure-temperature sensor downstream of the plurality of orifice plate lines.

6. The fuel metering valve system of claim 1, wherein the plurality of differently sized orifice plates comprises a parallel arrangement.

7. The fuel metering valve system of claim 1, wherein the plurality of orifice plate line valves comprises a plurality of solenoid valves.

8. The fuel metering valve system of claim 1, wherein the plurality of orifice plate line valves comprises a plurality of on and off valves.

9. The fuel metering valve system of claim 1, further comprising a flow controller in communication with the plurality of orifice plate line valves.

10. The fuel metering valve system of claim 1, wherein a first of the plurality of differently sized orifice plates comprises a first size, wherein a second of the plurality of differently sized orifice plates comprises a second size, and wherein the second size is about twice the first size.

11. The fuel metering valve system of claim 1, further comprising a fuel metering valve positioned in parallel or in series.

12. The fuel metering valve system of claim 1, wherein the plurality of differently sized orifice plates comprises six or more orifice plates.

13. The fuel metering valve system of claim 1, wherein the plurality of differently sized orifice plates comprises twelve or more orifice plates.

14. The fuel metering valve system of claim 1, wherein the plurality of differently sized orifice plates comprise a first size to accommodate about 0.1 percent or less of the flow of fuel and an N-th size to accommodate about 50 percent of the flow of fuel.

15. A method of providing a flow of fuel to a combustor of a gas turbine engine, comprising:
providing a plurality of differently sized orifice plates in a parallel arrangement in communication with the flow of fuel;
opening a first one of the plurality of differently sized orifice plates to meet a first fuel demand;
opening a second one of the plurality of differently sized orifice plates to meet a second fuel demand; and
opening all of the plurality of differently sized orifice plates to meet a full load fuel demand.

16. A fuel metering valve system for use with a flow of fuel in a gas turbine engine, comprising:
a plurality of orifice plate lines positioned in a parallel arrangement;
a plurality of differently sized orifice plates;
a plurality of orifice plate line valves; and
a flow controller in communication with the plurality of orifice plate line valves so as to open and close the plurality of orifice plates.

17. The fuel metering valve system of claim 16, further comprising an inlet manifold and an outlet manifold in communication with the plurality of orifice plate lines.

18. The fuel metering valve system of claim 16, further comprising an upstream pressure-temperature sensor upstream of the plurality of orifice plate lines and a downstream pressure-temperature sensor downstream of the plurality of orifice plate lines.

19. The fuel metering valve system of claim 16, wherein the plurality of orifice plate line valves comprises a plurality of solenoid valves.

20. The fuel metering valve system of claim 16, wherein a first of the plurality of differently sized orifice plates comprises a first size, wherein a second of the plurality of differently sized orifice plates comprises a second size, and wherein the second size is about twice the first size.
